(19) United States
(12) Patent Application Publication
(10) Pub. No.: US 2005/0029469 A1
(43) Pub. Date: Feb. 10, 2005

(54) Method for detecting foreign bodies within a continuously guided product stream and apparatus for carrying out the method

(75) Inventors: Dierk Schroder, Hamburg (DE); Harry Drewes, Hamburg (DE); Frank Schuster, Hamburg (DE); Siegfried Hapke, Geesthacht (DE); Michael Ibel, Halstenbek (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/892,165

(22) Filed: Jul. 16, 2004

(30) Foreign Application Priority Data
Jul. 17, 2003 (EP) 03 09 0222.5

(51) Int. Cl. G01N 21/64

(52) U.S. Cl. 250/458.1; 356/338; 356/342

(57) ABSTRACT

Method and apparatus for detecting foreign bodies within a continuously guided product stream. The method includes forming a fan-shaped light beam from collimated irradiation light, irradiating the product stream across its width with the fan-shaped light beam, and detecting at least a portion of detection light emanating from the product stream. The irradiating and detecting take place at least partially along a same optical beam path. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of European Patent Application No. 03 09 0222.5 filed Jul. 17, 2003, the disclosure of which is expressly incorporated by reference herein in its entirety.

### BACKGROUND OF THE INVENTION

1. Field of the Invention

The invention present invention is directed to a method for detecting foreign bodies within a continuously guided product stream that includes irradiation of the product stream with collimated irradiation light, and detection of at least a portion of the detection light emanating from the product stream by interaction with the collimated irradiation light. In this manner, the irradiation and detection take place at least partially in the same optical beam path.

Furthermore, the invention is directed to an apparatus for detecting foreign bodies within a continuously guided product stream. The apparatus includes an irradiation device for irradiation of the product stream, and a detection device for the detection of at least a portion of the detection light emanating from the product stream by interaction with the irradiation light. In this way, the irradiation device and the detection device are arranged in such a way that the optical beam paths of irradiation and detection at least partially coincide. A beam splitter for separating the irradiation light from the detection light is also included.

2. Discussion of Background Information

Methods and apparatuses of this kind are used differently in order to detect foreign bodies within a product stream and then also sort them out straightaway. In the tobacco-processing industry, the mentioned methods and apparatuses are used to detect unprocessable and/or unwanted constituents, such as e.g. foil remains, paper remains or the like, within a tobacco stream which is conveyed continuously and appropriately in planar fashion, and to separate them out of the product stream.

To detect the foreign bodies in a product stream, in particular in a tobacco stream, there are different approaches. With one known method the foreign bodies are detected with a camera. The illumination required for detection, namely, irradiation of the product stream, is effected by lamps arranged in a line, which are installed on both sides of the camera. With this method or this apparatus arrangement, the optical beam paths of the camera on the one hand and the lamps on the other hand are at an angle to each other, so that a shadow effect occurs. With foreign bodies to be measured, which may overlap each other since the tobacco stream can be transported in several planes, a shadow of an upper foreign body can be thrown over a lower foreign body, which leads to a false assessment in evaluation of the pictures taken with the camera. Thus the detection sensitivity of this method or apparatus, respectively, in the detection of foreign bodies in a tobacco stream is low.

To avoid the problem of the shadow effect, in a further known method a laser beam is passed through a static optical element and then moved transversely to the direction of transport of the product stream over the latter. This movement can be effected e.g. by a further optical element, preferably a revolving mirror, which deflects the laser beam. The laser beam is thus moved time-dependently transversely to the direction of transport of the product stream, that is, of the material to be measured, over the material to be measured. In other words, the product stream is displaced in time, that is, successively scanned by the laser beam across the whole width. The light returning from the product stream is at least partially returned in the reverse direction in the same optical axis, i.e. the optical beam path, and laterally deflected on the above-mentioned static optical element, in order then to be picked up in a detection device. A disadvantage of this method and construction is that the revolving optical element allows only a limited speed of rotation. As the product stream is transported at a high speed of transport, scanning of the product stream is possible only at intervals, usually about every 4 mm in the direction of transport of the product stream. As a result, the resolution of the image analysis and hence the detection of foreign bodies is greatly restricted. A further disadvantage lies in that the speed of rotation or circumferential speed of the revolving mirror is sufficient to lead to wear on the optical surfaces of the mirror due to particles of dust in the air. As a result, the life of the revolving mirror is limited. Moving parts are subject to wear, anyway, and thereby form a potential error source.

### SUMMARY OF THE INVENTION

Therefore, the present invention is directed to a method which, in a simple and fault-free manner, provides reliable detection of foreign bodies in a product stream with high detection sensitivity. Furthermore, the invention provides a simple apparatus by which the detection of foreign bodies in a product stream is reliably guaranteed.

According to the invention, the method, in addition to the above-mentioned features, includes that the product stream is irradiated simultaneously across its whole width. The collimated irradiation light is for this purpose expanded into a fan-shaped light beam for linear illumination of the product stream. As a result, in a surprisingly simple manner, it is ensured that the product stream is covered in its whole width and tested for foreign bodies with high detection sensitivity. Due to linear irradiation, parallel and simultaneous photographing of the product stream across its whole width is possible, so that structurally elaborate devices which limit the resolution of the product stream can be dispensed with. As a result, very high detection sensitivity to foreign bodies within the product stream is ensured, even when foreign bodies in different planes overlap. Specifically, an improved resolution higher than 4 mm is ensured.

Preferably, the irradiation light is composed of several light beams having different wavelengths. As a result, depending on the number of different wavelengths of the irradiation light, the differences in the detection light can be evaluated more easily and clearly, so that the result of evaluation is improved. Foreign bodies which would not be detected if a single wavelength were used are now detectable by the step according to the invention.

In a preferred development of the method, collimated irradiation light includes visible or near infrared light is used. By this choice, in a particularly simple and precise manner the detection of reflected light at different wavelengths is possible, as irradiation takes place at a high intensity, whereby detection of the foreign bodies is effected by the contrast at the different working wavelengths. In other words, the different reflection properties of the foreign bodies on the one hand and of the product stream on the other hand, namely, e.g. the tobacco, are particularly emphasized.

In another preferred embodiment of the method, collimated irradiation light composed of infrared light is used. With this light spectrum, inter alia the measurement of water lines and other reactions occurring in the infrared light spectrum, e.g. reflection, is possible with the irradiation light. It is precisely tobacco and other plant substances that as a rule have a water content which is lacking in the most important and commonest foreign substances. Thus, in a simple manner it is possible to distinguish the foreign bodies reliably from the usable and processable product stream. The same also applies to the detection of predefined organic compounds within the product stream which have a characteristic reaction with infrared light and so are easy to detect.

Advantageously, collimated irradiation light composed of ultraviolet light is used. Thereby, a particularly high radiation intensity at the product stream and hence also at the detection device is ensured, whereby the relative sensitivity during detection is improved. In other words, in this way even minimal differences in composition of the product stream can be detected. Thus different fluorescence phenomena of the fermented tobacco and foreign bodies can be used selectively for sorting.

In a further preferred embodiment of the invention, irradiation of the product stream with light beams of different wavelength, and detection of the reflected and/or fluoresced detection light, take place at different times. With this method, also known by the name “time multiplex”, the detection of reflected and/or fluoresced light is possible with a single detection device, preferably a single camera, for the different irradiation conditions. In time multiplex measurement, the light sources are each successively switched on according to a predetermined time pattern, so that illumination is carried out at one time with one wavelength, only. Therefore, at this time, reflection can also be effected only by precisely this wavelength. Therefore, a line array which is sensitive to all the wavelengths used is sufficient. The reflection data can, therefore, be determined with a single fast camera. Furthermore, cyclic excitation and detection make it possible to dispense with optical device for wavelength selection, e.g. filters or grids, so that the method is simplified and at the same time the sensitivity of measurement is improved. In other words, by the time multiplex method, an additional measurement option, i.e., the measurement of integral signals over a wavelength range, with simultaneous assignment to the respective irradiation light, is made possible.

Furthermore, the invention provides an apparatus of the kind mentioned hereinbefore that includes, in the optical beam path of the irradiation device and in front of the beam splitter, a device for the linear expansion of a light beam. Thus, a structurally particularly simple but very precisely operating apparatus is provided. With this apparatus, in a surprisingly simple manner it is ensured that the product stream can be detected simultaneously in its whole width and tested for foreign bodies with high detection sensitivity. Due to the device arranged outside the detection light, linear irradiation and hence parallel and simultaneous photographing of the product stream across its whole width is possible, so that structurally elaborate device which limit the resolution of the product stream can be dispensed with. As a result, very high detection sensitivity to foreign bodies within the product stream is ensured, even when foreign bodies in different planes overlap.

In a preferred development of the invention, the apparatus includes at least one laser as a light source, which is constructed in such a way that it works simultaneously with several wavelengths. Thus, the structural design is further substantially simplified and allows a very small and compact overall size.

Advantageously, the irradiation light is in the visible and/or near infrared and/or infrared and/or ultraviolet spectral range. Thus, a plurality of analysis options can be produced, which can be selected according to the product to be tested and the required detection sensitivity.

The present invention is directed to a method for detecting foreign bodies within a continuously guided product stream. The method includes forming a fan-shaped light beam from collimated irradiation light, irradiating the product stream across its width with the fan-shaped light beam, and detecting at least a portion of detection light emanating from the product stream. The irradiating and detecting take place at least partially along a same optical beam path.

According to a feature of the invention, a whole width of the product stream can be simultaneously irradiated.

In accordance with another feature of the present invention, the detection light results from interaction between the product stream and the irradiation light.

Moreover, the irradiation light can be composed of a plurality of light beams having different wavelengths.

Further, the irradiation light can be composed of at least one laser beam. The at least one laser beam may include a plurality of laser beams deflected into a combined and expanded light beam.

Irradiation light can be composed of collimated light including at least one of visible light, near infrared light, infrared light, and ultraviolet light.

According to another feature, the detected light may include at least one of reflected and fluoresced detection light. The reflected detection light can be picked up at different wavelengths by different cameras. Detection of foreign bodies can be effected by contrasts at the different wavelengths. Further, the collimated irradiation light may be composed of light beams of varying wavelength, and the detecting of the at least one of reflected and fluoresced detection light can occur at different times.

In accordance with a further feature of the instant invention, the method can also include filtering the detection light.

The method can also provides that light intensity of the irradiation light may be calibrated.

According to the method, the irradiation light can be composed of a light source having at least three different wavelengths, which are described by corresponding points in an at least 3-dimensional space.

The invention is directed to an apparatus for detecting foreign bodies within a continuously guided product stream. The apparatus includes an irradiation device for irradiating the product stream with irradiation light, and a detection device for detecting at least a portion of detection light emanating from the product stream. An optical beam path from the irradiation device at least partially coincides with an optical beam path of the detection device. A beam splitter is included for separating the irradiation light from the detection light and a device for forming a fan-shaped beam from the irradiating light is provided to illuminate the product stream across its width.

In accordance with a feature of the invention, the device for forming the fan-shaped beam can include a device for linear expansion of the irradiation beam.

According to another feature of the instant invention, the device for forming the fan-shaped beam can be positioned in front of the beam splitter with respect to an irradiation direction.

In accordance with the present invention, the detection light can result from an interaction between the product stream and the irradiation light.

Further, the irradiation device can include at least one light source. The at least one light source may include a laser, and the laser can be structured to simultaneously illuminate with several wavelengths. Further, the at least one light source may include a plurality of light sources, and each of the plurality of light sources may include a laser. At least one laser may be structured to simultaneously illuminate with several wavelengths. Moreover, each light source can include an optical beam path and a beam splitter is arranged in the optical beam path of each light source.

According to the invention, the detection device can include at least one line camera. The light source may include a plurality of laser sources and the at least one line camera can include a line camera having a number of line corresponding to the number of laser sources.

The detection device can include at least one line camera, and each light source may be assigned a line camera, and each line camera may be sensitive to different spectral ranges. Further, n line cameras can be assigned to (n-1) beam splitters. The light sources may include lasers, and the at least one line camera can include a line camera with a number of lines corresponding to the number of lasers. Each line of a line camera may be sensitive to different spectral ranges.

Moreover, each light source can include an optical beam path and a line camera and at least one of an optical filter and a polarisation filter can be arranged in each optical beam path.

According to still another feature of the invention, the irradiation light may include light in at least one of the visible, near infrared, infrared, and ultraviolet spectral range.

In accordance with still yet another feature of the present invention, the apparatus can further include a reflection element located on a side of the product stream opposite an irradiated side of the product stream. The reflection element can have reflection properties that substantially match those of the product stream.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings:

FIG. 1 shows a side view of a preferred embodiment of the apparatus according to the invention;

FIG. 2 shows a top view of the apparatus as depicted in FIG. 1; and

FIG. 3 shows a diagram to show the principle of the description of intensities of at least three different wavelengths by corresponding points in the at least 3-dimensional space.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The shown apparatus serves to detect foreign bodies within a continuously guided product stream which preferably includes tobacco.

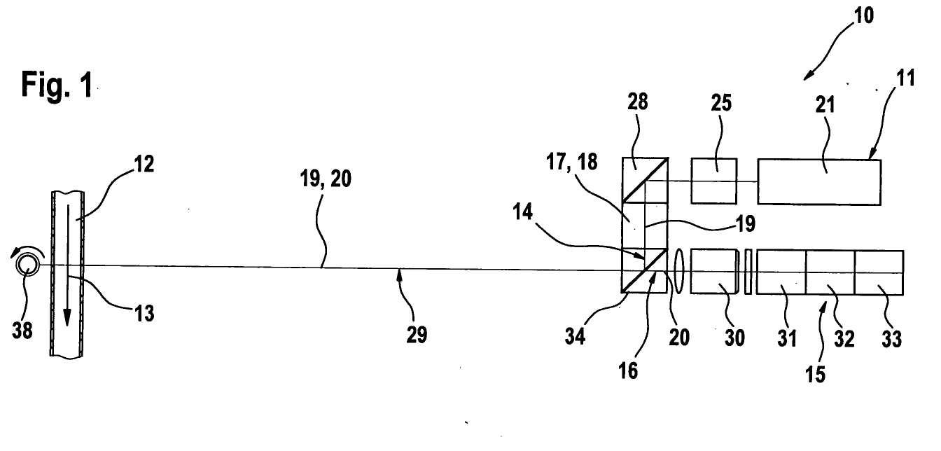

The apparatus 10 shown in FIG. 1 includes an irradiation device 11 for irradiating with irradiation light 14 a product stream 13 conveyed within a flow channel 12 or the like. Product stream 13 is preferably composed of tobacco and is transported in a free flight zone. A detection device 15 is arranged to detect at least a portion of detection light 16 emanating from product stream 13 as a result of interaction with irradiation light 14, and a device 17 is arranged for linear expansion of the irradiated light, which can be formed of one or more light beams. Device 17 is constructed or formed as a beam expander 18 arranged in optical beam path 19 of irradiation device 11. Irradiation device 11 and detection device 15 are arranged relative to each other in such a manner that optical beam path 19 of irradiation device 11 and optical beam path 20 of detection device 15 at least partially coincide, i.e., at least partially form or are aligned a same optical axis.

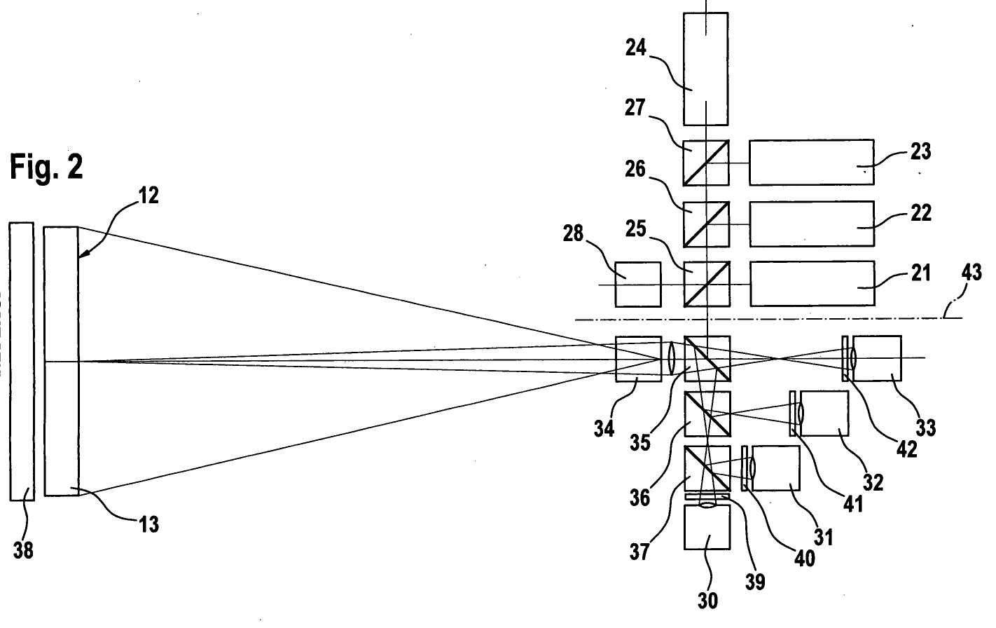

Irradiation device 11 includes at least one light source 21. however, in the exemplary embodiment shown in FIG. 2, four light sources 21, 22, 23, 24 are utilized. Light source 21 or at least one of light sources 21 to 24 is preferably designed or formed as a laser. Of course, other light sources can be used as well. Further, light sources 21 to 24 can be structured to radiate light of different wavelengths. Moreover, a single laser which illuminates simultaneously with several wavelengths can be used. In each optical beam path of each light source 21 to 24, an optical element, which is appropriately designed as a beam splitter 25, 26, 27, can be arranged. In this regard, light sources 23 and 24 have a common beam splitter 27. Through beam splitters 25 to 27, collimated light beams of light sources 21 to 24 are focused in such a way that they are deflected via a mirror 28 and a central beam splitter 34 arranged behind mirror 28, and into a single combined light beam 29 onto the product stream 13. Central beam splitter 34 separates, as it were, irradiation light 14 from detection light 16, such that beam splitter 34 splits the optical beam path into a forward and a return path. Beam expander 18 is arranged in front of central beam splitter 34, so that the light beam is expanded in front of the coinciding section of beam paths 19 and 20.

Detection device 15 includes at least one camera. However, it is noted that four cameras 30, 31, 32, and 33 are arranged in the embodiment shown in FIGS. 1 and 2. Alternatively, however, a single camera with several lines can be used, such that the number of lines appropriately correspond to the number of light sources 21 to 24. Each light source 21 to 24 or each laser beam is assigned a camera 30 to 33. Preferably, cameras 30 to 33 are designed as line cameras. Each of cameras 30 to 33 has its own sensitivity to different spectral ranges, for all the embodiments described with the exception of the time multiplex method described later. In the event that a single camera with several lines is used, each line is sensitive to a different spectral range.

In each optical beam path 20 of each camera 30 to 33, an optical element which is appropriately designed as a beam splitter 35, 36, and 37 is arranged. Cameras 30 and 31 have a common beam splitter 37 in the illustrated embodiment. Cameras 30 to 33 are adjustable in such a way that the line which is illuminated on product stream 13 can be imaged precisely on the line of each individual camera 30 to 33.

To show it better, apparatus 10 in FIG. 2 is shown slightly offset. To be more precise, elements 21 to 28 are shown offset parallel to imaginary axis 43. In the actual apparatus 10, mirror 28 is located above central beam splitter 34 and beam splitter 25 is arranged above beam splitter 35.

Optionally, in each optical beam path of cameras 30 to 33, an optical filter 39, 40, 41, and 42 and/or a polarisation filter can be arranged. Further, irradiation light 14 can be, e.g., in the visible and/or near infrared and/or infrared and/or ultraviolet spectral range. This essentially depends on the selected analysis of detection light 16 and is described in more detail below. In order to be able to calibrate the respective light intensity of the irradiation light 14, a reflection element with a background frequency is provided. Appropriately, the reflection properties of the reflection element correspond to those of product stream 13. Thus, the simultaneous effect is that during detection of product stream 13 there are only two reflection bodies, i.e., the tobacco as part of product stream 13, and the foreign bodies contained in product stream 13. Therefore, should a fault arise within product stream 13, this would be detected as a foreign body not because of reflection properties deviating from tobacco, but because the reflection properties of the reflection element correspond to those of product stream 13, creating the impression as if tobacco were present.

This background frequency is designed as a background roller 38 in the exemplary embodiment of FIG. 2. Background roller 38 is rotatable and arranged on the side of flow channel 12 facing away from product stream 13. Flow channel 12 is preferably constructed as a mechanical component, e.g., as a rectangular shaft or as a stream defined by product stream 13 itself, e.g., a stream describing a flight path whose outer boundary is formed by the product stream 13 itself, so that at the same time a cleaning effect is obtainable, e.g. by cyclic stripping of deposits. Instead of background roller 38, a belt or the like can be provided. Alternatively, the reflection element can also be an active light source.

In a not-shown embodiment, apparatus 10 can also be arranged on both sides of product stream 13. In this manner, the mutually opposed apparatuses 10 must then be offset from each other in height, that is, one above the other. By such an arrangement, scanning of product stream 13 on both sides can take place, so that a higher layer thickness of product stream 13 can be detected, which in turn increases the throughput of tobacco.

The different variants of the methods proceed as follows:

For all the methods described below it is true that one or more strongly collimated light beams, e.g. laser beams, from light sources 21 to 24 are deflected via beam splitters 25 to 27 via mirror 28 and beam splitter 34 as the combined light beam 29 directed onto product stream 13. Light beam 29, however, is expanded in optical beam path 19 by beam expander 18 into fan-shaped light beam 29, so that light beam 29 on product stream 13 describes a line across the whole width of the product stream 13. In other words, the light beam 29 is expanded in one axis.

For the method described with the aid of FIGS. 1 and 2, cameras 30 to 33 are adjusted via beam splitters 35 to 37 such that the illuminated line on product stream 13 is imaged precisely on the line of each individual camera 30 to 33. Alternatively, each camera 30 to 33 can be, in each case, sensitive to several spectral ranges—e.g. red, green and blue light—or an optical filter 39, 40, 41, 42 which filters the desired wavelengths and lets only selected optical wavelength ranges through to the respective camera 30 to 33 can be arranged in each beam path of the detected light. As light sources 21 to 24 in this embodiment work in a spectral range of visible or near infrared light, reflection is measured at different wavelengths by cameras 30 to 33. Detection of the foreign bodies is effected finally by a measurable contrast at the different working wavelengths.

In another embodiment, one or more light sources 21 to 24 can operate in the infrared spectral range, i.e., in the range of water lines. As plant material to be measured, the material, which includes tobacco, basically has a measurable water content. However, as most serious foreign bodies do not have a water content, these foreign bodies can easily be distinguished from the actual material to be processed. For this, product stream 13 is, as already mentioned for the other practical example, irradiated with the infrared light. Reflected detection light 16 is picked up by one or more cameras 30 to 33 and evaluated on the basis of the effect of water lines.

In a further embodiment, the light generated by fluorescence is used as detection light 16 in the detection of foreign bodies. In particular, fermented tobacco fluoresces clearly when excited with ultraviolet light. The fluorescence of tobacco in the visible spectral range is still characteristic. Different foreign bodies fluoresce only weakly or with a characteristic color, so that the foreign bodies can be inferred by analysis of the fluorescence. Product stream 13 is therefore, as in the method described before, irradiated with irradiation light 14 from one or more light sources 21 to 24, in which irradiation light 14 can be in the ultraviolet spectral range. One or more cameras 30 to 33 pick up the fluorescent light, such that the fluorescent light selects suitable wavelengths by filters 39 to 42. The wavelengths are selected in such a way that foreign bodies are distinguished from the material to be measured.

In a further method according to the invention, irradiation with light of different wavelength is effected by one or more light sources 21 to 24 at different times. In other words, the different exciting wavelengths are controlled cyclically at different times. The or each camera 30 to 33 is selected with each of these excitations, wherein the or each camera 30 to 33 can pick up both reflected light and fluorescent light.

There is also the possibility of passing the reflected light or fluorescent light through suitable polarization filters which are arranged in the beam path of the detection light. The polarization filters make a distinction with respect to the direction of polarisation. Already irradiation takes place here with polarized light. The irradiation light can be polarized by suitable filters. However, alternatively, the light source itself can give off polarized light.

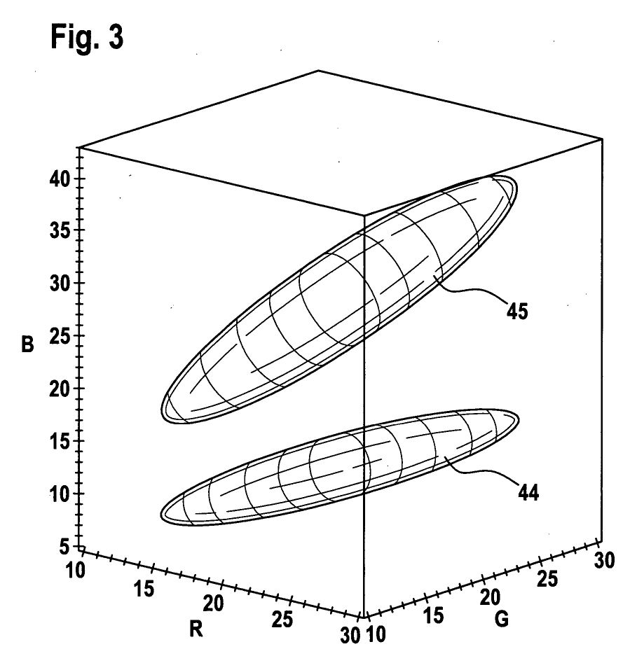

In analysis of detection light 16, in addition to the conventional methods of analysis an n-dimensional analysis can be made. This means that intensities of n different wavelengths are described by corresponding points in the n-dimensional space. The method of analysis is described with the aid of FIG. 3 by the example of intensities of three different wavelengths, e.g. with RGB signals (red, green, blue). A point in the space characterizes the intensities of the RGB signals. Each product stream 13 has typical reflection signals. In the case of tobacco, the typical-reflection signals are in the cigar-shaped region marked 44. The cigar shape of the region 44 arises due to the color compositions varying approximately proportionally to each other in case of fluctuations of intensity. All points within region 44 correspond to product stream 13 to be tested, that is, the tobacco. All points which lie outside region 44 basically come from a foreign body. Since the foreign bodies of one type, e.g. film remains, have fluctuations of intensity too, a cigar-shaped region 45 also arises for each type. In the view shown, the foreign body has a much higher proportion of blue signal than tobacco, so that detection of the foreign body is particularly easy.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made within the purview of the appended claims, as presently stated and as amended, without departing from the scope and spirit of the present invention in its aspects. Although the present invention has been described here in with reference to particular means, materials and embodiments, the present invention is not intended to be limited to the particulars disclosed herein; rather, the present invention extends to all functionally equivalent structures, methods and uses, such as are within the scope of the appended claims.

1. A method for detecting foreign bodies within a continuously guided product stream, comprising:
forming a fan-shaped light beam from collimated irradiation light;
irradiating the product stream across its width with the fan-shaped light beam; and
detecting at least a portion of detection light emanating from the product stream,
wherein the irradiating and detecting take place at least partially along a same optical beam path.

2. The method in accordance with claim 1, wherein a whole width of the product stream is simultaneously irradiated.

3. The method in accordance with claim 1, wherein the detection light results from interaction between the product stream and the irradiation light.

4. The method in accordance with claim 1, wherein the irradiation light is composed of a plurality of light beams having different wavelengths.

5. The method in accordance with claim 1, wherein the irradiation light is composed of at least one laser beam.

6. The method in accordance with claim 5, wherein the at least one laser beam comprises a plurality of laser beams deflected into a combined and expanded light beam.

7. The method in accordance with claim 1, wherein irradiation light is composed of collimated light including at least one of visible light, near infrared light, infrared light, and ultraviolet light.

8. The method in accordance with claim 1, wherein the detected light comprises at least one of reflected and fluoresced detection light.

9. The method in accordance with claim 8, wherein the reflected detection light is picked up at different wavelengths by different cameras.

10. The method in accordance with claim 8, wherein detection of foreign bodies is effected by contrasts at the different wavelengths.

11. The method in accordance with claim 8, wherein the collimated irradiation light is composed of light beams of varying wavelength, and the detecting of the at least one of reflected and fluoresced detection light occurs at different times.

12. The method in accordance with claim 1, further comprising filtering the detection light.

13. The method in accordance with claim 1, wherein light intensity of the irradiation light is calibrated.

14. The method in accordance with claim 1, wherein the irradiation light is composed of a light source having at least three different wavelengths, which are described by corresponding points in an at least 3-dimensional space.

15. An apparatus for detecting foreign bodies within a continuously guided product stream, comprising:
an irradiation device for irradiating the product stream with irradiation light;
a detection device for detecting at least a portion of detection light emanating from the product stream, wherein an optical beam path from said irradiation device at least partially coincides with an optical beam path of said detection device;
a beam splitter for separating the irradiation light from the detection light; and
a device for forming a fan-shaped beam from the irradiating light to illuminate the product stream across its width.

16. The apparatus in accordance with claim 15, wherein said device for forming the fan-shaped beam comprise a device for linear expansion of the irradiation beam.

17. The apparatus in accordance with claim 15, wherein said device for forming the fan-shaped beam is positioned in front of said beam splitter with respect to an irradiation direction.

18. The apparatus in accordance with claim 15, wherein the detection light results from an interaction between the product stream and the irradiation light.

19. The apparatus in accordance with claim 15, wherein said irradiation device comprises at least one light source.

20. The apparatus in accordance with claim 19, wherein said at least one light source comprises a laser.

21. The apparatus in accordance with claim 20, wherein said laser is structured to simultaneously illuminate with several wavelengths.

22. The apparatus in accordance with claim 19, wherein said at least one light source comprises a plurality of light sources.

23. The apparatus in accordance with claim 22, wherein each of said plurality of light sources comprises a laser.

24. The apparatus in accordance with claim 23, wherein at least one laser is structured to simultaneously illuminate with several wavelengths.

25. The apparatus in accordance with claim 22, wherein each light source comprises an optical beam path and a beam splitter is arranged in the optical beam path of each light source.

26. The apparatus in accordance with claim 15, wherein said detection device comprises at least one line camera.

27. The apparatus in accordance with claim 26, wherein said light source comprises a plurality of laser sources and said at least one line camera comprises a line camera having a number of line corresponding to the number of laser sources.

28. The apparatus in accordance with claim 19, wherein said detection device comprises at least one line camera, and each light source is assigned a line camera.

29. The apparatus in accordance with claim 28, wherein each line camera is sensitive to different spectral ranges.

30. The apparatus in accordance with claim 29, wherein n line cameras are assigned to (n−1) beam splitters.

31. The apparatus in accordance with claim 28, wherein said light sources comprise lasers, and said at least one line camera comprises a line camera with a number of lines corresponding to the number of lasers.

32. The apparatus in accordance with claim 31, wherein each line of a line camera is sensitive to different spectral ranges.

33. The apparatus in accordance with claim 22, wherein each light source comprises an optical beam path and a line camera and at least one of an optical filter and a polarisation filter are arranged in each optical beam path.

34. The apparatus in accordance with claim 15, wherein the irradiation light comprises light in at least one of the visible, near infrared, infrared, and ultraviolet spectral range.

35. The apparatus in accordance with claim 15, further comprising a reflection element located on a side of the product stream opposite an irradiated side of the product stream.

36. The apparatus in accordance with claim 35, wherein said reflection element has reflection properties that substantially match those of the product stream.
